(19) United States
(12) Patent Application Publication
(10) Pub. No.: US 2004/0240366 A1
(43) Pub. Date: Dec. 2, 2004

(54) Recording disc, recording device, and recording method

(76) Inventor: Yoshimi Tomita, Saitama (JP)

Correspondence Address: MORGAN LEWIS & BOCKIUS LLP, 1111 PENNSYLVANIA AVENUE NW, WASHINGTON, DC, 20004, US

(21) Appl. No.: 10/489,671

(22) PCT Filed: Apr. 1, 2003
(86) PCT No.: PCT/JP03/04177

(30) Foreign Application Priority Data
Apr. 15, 2002 (JP) 2002-111815

(51) Int. Cl. G11B 5/09; G11B 7/24

(52) U.S. Cl. 369/59.25; 369/275.3; 369/47.15; 369/47.27

(57) ABSTRACT

A recording disc capable of recording a recording mark in a reproduction control data area of a recording disc for authoring. In the recording disc, a disc address indicating a position on the disc is recorded at a constant linear velocity in advance and has an information data area where a recording mark string carrying information data is recorded. Further, this recording disc includes a reproduction control data area where a disc address is recorded at a constant angular velocity in advance and recording marks in the recording mark string carrying the reproduction control data are to be recorded in the direction orthogonal to a plurality of adjacent tracks.

### TECHNICAL FIELD

The present invention relates to a recording disc, a recording device for recording information data on the recording disc, and a recording method for recording information data on the recording disc.

### BACKGROUND ART

DVD-Rs, which are a write-once type recording disc, are categorized into DVD-Rs for general use and DVD-Rs for authoring. The former is developed in consideration of copy protection. The latter is sold to contract purchasers only.

In general, the authoring DVD-Rs are used for authoring music and image (video) contents which are ultimately recorded on read-only recording discs such as DVD-ROMs. For the authoring, firstly, the music and image contents undergo editing and signal processing to create a single work (authoring) to be recorded on the DVD-ROM. Before it is recorded on the DVD-ROM, the work is recorded on the authoring DVD-R. The recorded information is reproduced from the authoring DVD-R, and a master disc is fabricated based on the reproduced information data. The master disc is used to make replica DVD-ROMs.

One kind of the next generation DVD-ROMs is illustrated in FIG. 1 of the accompanying drawings. The DVD-ROM 5 has a lead-in area 2, an information data area 1 for recording information data, a lead-out area 3, and a PEP (phase encoded part) area 4. The PEP area 4 is an area for recording reproduction control data. The reproduction control data includes, for example, a tracking method that is used to read the recorded information from the disc 5, and a decoding method for the information data recorded in the information data area 1 and related information. The decoding method and related information are phase-encode modulated before they are recorded in the PEP area 4.

FIG. 2 of the accompanying drawings illustrates a detailed structure of the lead-in area 2, information data area 1 and PEP area 4 of the above described DVD-ROM 5.

The lead-in area 2, information data area 1 and PEP area 4 are formed as shown in FIG. 2. In the information data area 1, a string of pits is defined by recordation pits Pt1 that represent the information data. In the lead-in area 2, a string of pits is defined by other recordation pits Pt1 that represent recording positions, ideal (required) reproducing times and related information of respective pieces of information data.

In the PEP area 4, signals which are phase-encode modulated in a similar manner to a recording method disclosed in Japanese Patent No. 2,543,523 are recorded. Specifically, the reproduction control data undergo a phase-encode modulation process to provide phase-encoded modulation signals. Based on the phase-encoded modulation signals, a string of recordation pits Pt2 is recorded as shown in FIG. 2. If one bit of recordation control data has (indicates) a logic level 0, a string of three recordation pits Pt2 is recorded in a half (left half) zone AM (i.e., data 0 zone) as shown in FIG. 2. The three recordation pits Pt2 have the same pit length. In the other half (right half) zone PM, no pits are recorded. If one bit of recordation control data has a logic level 1, no pits are recorded in the first half zone AM (i.e., data 1 zone) as shown in FIG. 2. In the second half zone PM, on the other hand, a string of three recordation pits Pt2 is recorded. The three recordation pits Pt2 have the same pit length. A string of recordation pits Pt2 is formed on one round of the disc along a track. Similar strings of recordation pits Pt2 (tracks) are formed in the circumferential direction of the disc next to each other. Therefore, the recordation pits Pt2 are aligned with each other when viewed in a direction perpendicular to a track direction, as shown in FIG. 2.

When a disc player starts reproducing the recorded information from the above-described next-generation DVD, the disc player first reads the reproduction control data from the PEP area 4. The disc player then performs the information reproducing process based on the reproduction method indicated by the reproduction control data.

Similarly, the next generation DVD-R for authoring has a reproduction control data area which is substantially equivalent to the PEP area 4. There is a disc recorder which is designed for authoring only. This disc recorder can record data on the authoring DVD-R. The disc recorder must record recordation marks in the reproduction control data area of the authoring DVD-R such that the recordation marks are aligned with each other in a direction perpendicular to the track direction, like the recordation pits Pt2 in the PEP area 4 shown in FIG. 2.

In order to record the recordation marks on a plurality of land tracks and align the recordation marks in the direction perpendicular to the track direction, the recordation timing of the recordation marks must be controlled precisely. In actuality, therefore, there is a high possibility of recording failure.

An object of the present invention is to provide a recording disc for authoring, recording device and recording method, which can record the recordation marks in the reproduction control data area of the recording disc in a desired manner.

### DISCLOSURE OF THE INVENTION

According to a first aspect of the present invention, there is provided a recording disc for recording information data and reproduction control data which represents a method of reproducing the information data. The recording disc includes an information data area for recording a string of first recordation marks which represents the information data. Addresses on the recording disc (disc addresses) are recorded in advance in the information data area at a constant linear velocity. The recording disc also includes a reproduction control data area for recording a plurality of strings of second recordation marks, which represent the reproduction control data, along a plurality of neighboring tracks respectively such that the second recordation marks align with each other in a direction perpendicular to a track direction. Disc addresses are recorded in advance in the reproduction control data area of the recording disc at a constant angular velocity.

According to a second aspect of the present invention, there is provided a recording device for recording information data and reproduction control data on a recording disc. The recording disc has an information data area to record the information data and a reproduction control data area to record the reproduction control data. The reproduction control data represents a method of reproducing the information data. The recording device includes information data area recording means for rotating the recording disc at a constant linear velocity and recording a string of first recordation marks, which represents the information data, on a track in the information data area. The recording device also includes reproduction control data area recording means for rotating the recording disc at a constant angular velocity, recording a disc-one-rotation-worth of string of second recordation marks, which represents the reproduction control data, along one track in the reproduction control data area, and repeatedly recording the same string of second recordation marks along at least one adjacent track in the reproduction control data area.

According to a third aspect of the present invention, there is provided a recording method of recording information data and reproduction control data on a recording disc. The recording disc has an information data area to record the information data and a reproduction control data area to record the reproduction control data. The reproduction control data represents a method of reproducing the information data. The recording method includes the step of rotating the recording disc at a constant linear velocity and recording a string of first recordation marks which represents the information data on a track in the information data area. The recording method also includes the step of rotating the recording disc at a constant angular velocity, recording a disc-one-rotation-worth of string of second recordation marks, which represents the reproduction control data, along one track in the reproduction control data area, and repeatedly recording the same string of second recordation marks along at least one adjacent track in the reproduction control data area.

Other aspects, objects and advantages of the present invention will become apparent when the following detailed description is read in conjunction with the accompanying drawings.

### BRIEF DESCRIPTION OF THE DRAWINGS

FIG. 1 illustrates an exemplary arrangement of recording areas on a next generation DVD-ROM;

FIG. 2 illustrates exemplary surface structures of an information data area, lead-in area and PEP area of the DVD-ROM shown in FIG. 1;

FIG. 3 illustrates a configuration of a machine for making a master disc which is used to fabricate recording discs for authoring according to an embodiment of the present invention;

FIG. 4A illustrates an example of a wobble signal waveform;

FIG. 4B illustrates another example of a wobble signal waveform;

FIG. 5 illustrates an arrangement of recording areas on the recording disc for authoring, according to the embodiment of the present invention;

FIG. 6 illustrates one example of surface structures of an information data area, lead-in area and PEP area of the recording disc for authoring, according to the embodiment of the present invention;

FIG. 7 illustrates a block diagram of a disc recorder for authoring only, according to the embodiment of the present invention;

FIG. 8 illustrates an arrangement of four optical detectors mounted in a recording/reproducing head;

FIG. 9A illustrates a waveform of a phase-encoding modulated signal which corresponds to one bit length worth of data; and

FIG. 9B illustrates a waveform of another phase-encoding modulated signal.

### MODE FOR CARRYING OUT THE INVENTION

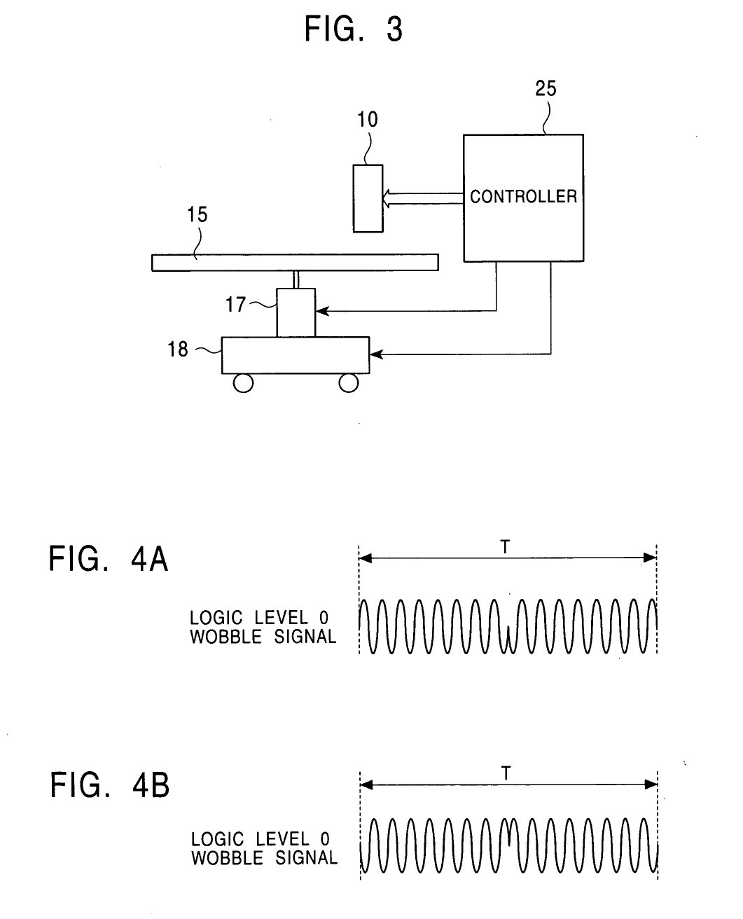

Referring to FIG. 3, schematically illustrated is an apparatus for fabricating a master disc, which is later used to fabricate recording discs for authoring, according to an embodiment of the present invention.

A master disc 15 has a resist layer formed on its upper surface. A spindle motor 17 rotates the master disc 15 at a constant angular velocity or a constant linear velocity. A feed stage 18 moves the master disc 15 and spindle motor 15 in a radial direction of the master disc 15. An electron beam device 10 irradiates an electron beam to the surface of the resist layer of the master disc 15.

A controller 25 controls the electron beam device 10, spindle motor 17 and feed stage 18 in a manner described below.

First, the controller 25 generates a wobble signal having a fixed amplitude. The wobble signal has a waveform that corresponds to a disc address, which indicates a position on the disc. For example, if one bit of the disc address indicates a logic level 1, the controller 25 generates a wobble signal having a waveform shown in FIG. 4A in a predetermined period T. If one bit of the disc address indicates a logic level 0, the controller 25 generates a wobble signal having a waveform shown in FIG. 4B in the predetermined period T. Then, the controller 25 controls (operates) the electron beam device 10 in order to oscillate the axis of the electron beam in the disc radial direction based on the wobble signal. As a result, the electron beam device 10 irradiates the electron beam on the resist layer of the master disc 15 while the electron beam axis is oscillating in the disc radial direction in accordance with the wobble signal of FIG. 4A or 4B. During this operation, the controller 25 controls the feed stage 18 such that the electron beam irradiation position on the resist layer surface gradually moves from the inside of the disc toward the outside of the disc.

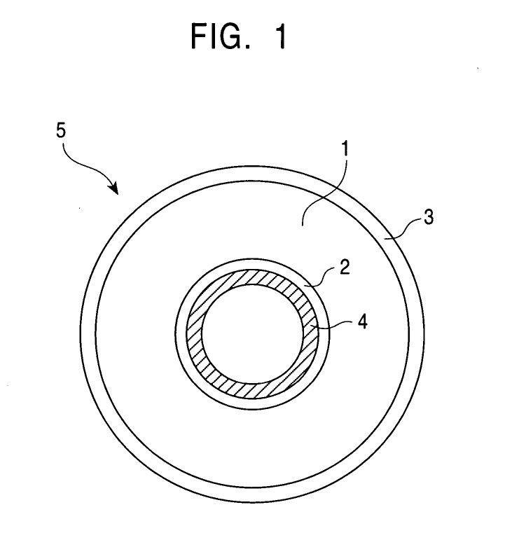

The controller 25 causes the spindle motor 17 to rotate such that a relative moving speed between a spot formed at a position of irradiation of the electron beam and the master disc surface is constant (fixed linear velocity) while the electron beam is being irradiated to those portions of the resist layer surface which correspond to the lead-in area 2 and information data area 1 shown in FIG. 1.

On the other hand, the controller 25 causes the spindle motor 17 to rotate such that the master disc 15 rotates at a constant angular velocity while the electron beam is being irradiated to those portions of the resist layer surface which correspond to the PEP area 4 shown in FIG. 1.

Consequently, a latent image is created on those parts of the resist layer of the master disc 15 which are irradiated by the electron beam. Specifically, a wobble latent image is spirally formed in the resist layer surface of the master disc 15 at those areas which correspond to the information data area 1, lead-in area 2 and PEP area 4 shown in FIG. 1.

When the recordation (i.e., formation of the latent image) on the resist layer of the master disc 15 is completed, only the latent image is removed from the resist layer to prepare a mask pattern. By using the mask pattern, a stamper is prepared which has concave and convex corresponding to the land track(s). Authoring discs are then fabricated by using the stamper.

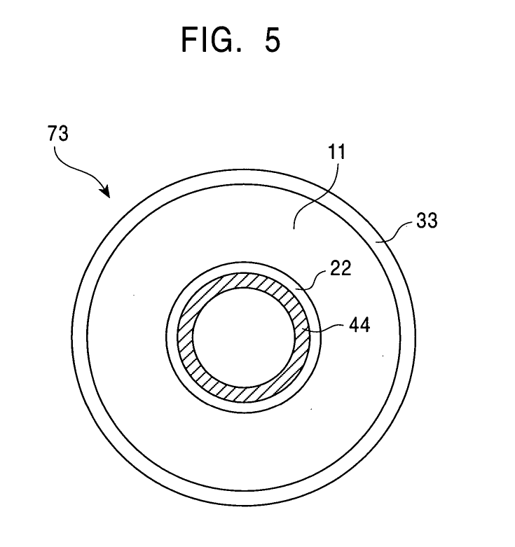

FIG. 5 illustrates recordation areas of the authoring disc made by the above described method.

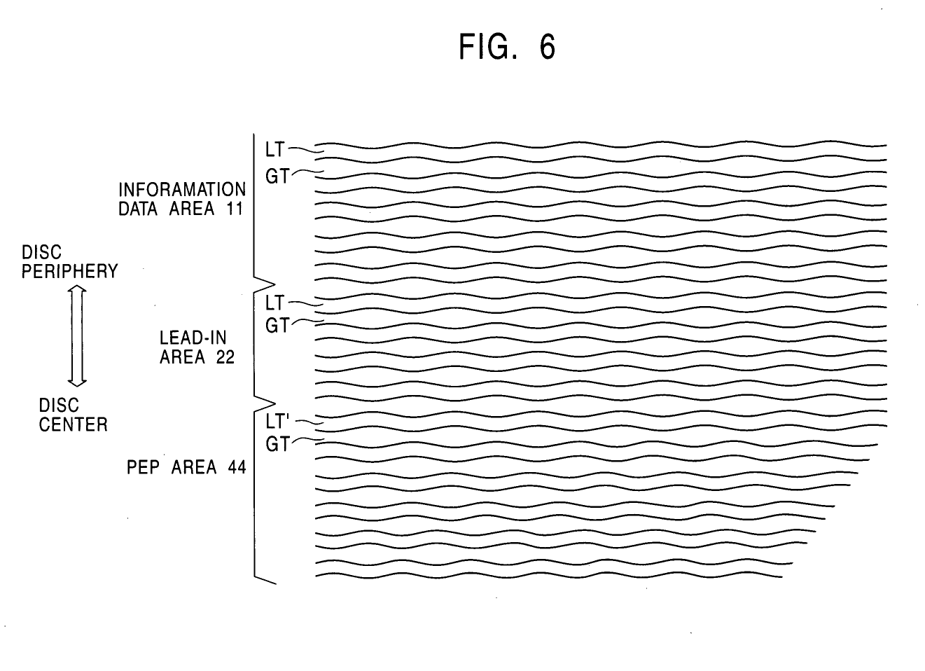

As depicted in FIG. 5, the recording disc 73 for authoring includes an information data area 11, a lead-in area 22, a lead-out area 33, and a PEP area 44 at respective positions similar to the information data area 1, lead-in area 2, lead-out area 3, and PEP area 4 of the next-generation read-only recording-disc shown in FIG. 1. Wobble land tracks LT, shown in FIG. 6, are spirally formed in each of the information area 11 and lead-in area 22. Between each adjacent land tracks LT, formed is a groove track GT. In the PEP area 44, which is designed to record the reproduction control data, another wobble land tracks LT′ are spirally formed. Between each adjacent land tracks LT′, formed is a groove track GT.

The land track LT that has a wobble configuration corresponding to the disc address is formed at a constant linear velocity in each of the information data area 11 and lead-in area 22. The land tracks LT′ are formed at a constant angular velocity in the PEP area 44.

In other words, although the disc address which indicates the position on the recording disc is recorded in the information data area 11 of the recording disc 73 at the constant linear velocity, the disc address is recorded in the PEP area 4 at the constant angular velocity.

The operation of the authoring-only disc recorder designed to write the information on the recording disc 73 will be described.

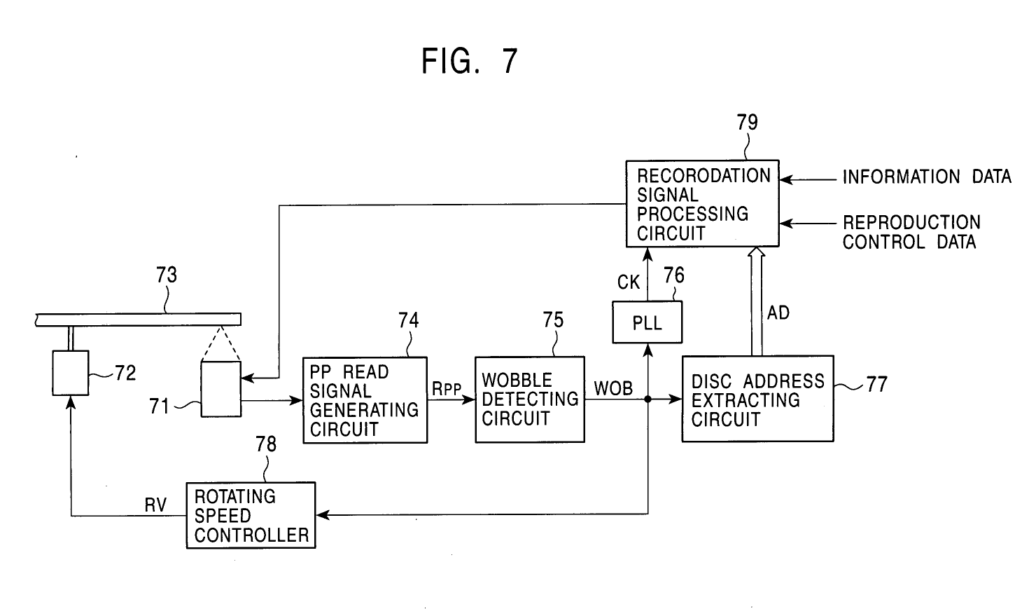

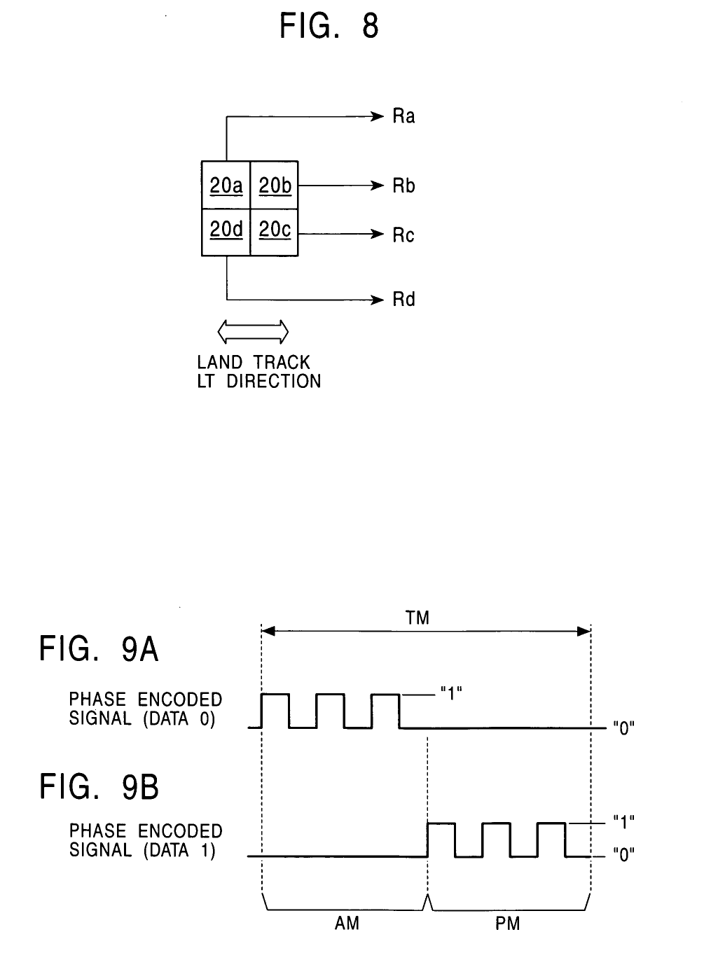

Referring to FIG. 7, the structure of the disc recorder for the authoring only is shown. A recordation/reproduction head 71 follows the land track LT formed on the recording disc 73 and irradiates a reading beam on the land track LT. The. recording disc 73 is rotated by a spindle motor 72. Four optical detectors 20a to 20d are arranged in the recordation/reproduction head 71 as illustrated in FIG. 8. The optical detectors 20a to 20d receive reflection light from the recording disc 73 respectively, and photo-electrically convert the reflection light to read signals Ra to Rd. Using the read signals Ra to Rd, a push-pull read signal generating circuit 74 performs the following calculation to produce a push-pull read signal Rpp, and supplies the push-pull read signal to a wobble detection circuit 75.

Rpp=(Ra+Rb)−(Rc+Rd)

The wobble detection circuit 75 uses the push-pull read signal Rpp to produce a wobble signal WOB which has a waveform corresponding to the wobbling shape of the land track LT (e.g., the waveform shown in FIG. 4A or 4B). The wobble detection circuit 75 supplies the wobble signal WOB to a PLL (phase locked loop) circuit 76, disc address extraction circuit 77 and rotation control circuit 78.

The PLL circuit 76 generates a clock signal CK having a predetermined frequency which is phase-synchronized with the wobble signal WOB, and supplies the clock signal to a recordation signal processing circuit 79. The disc address extraction circuit 77 uses the waveform of the wobble signal WOB, as shown in FIG. 4A or 4B, to extract the address on the recording disc 73 (disc address) currently traced by the recordation/reproduction head 71. The disc address extraction circuit 77 then supplies a disc address signal AD, which indicates the disc address, to the recordation signal processing circuit 79. The rotation speed controlling circuit 78 generates a rotation speed signal RV which specifies (determines) an appropriate rotation speed to cause the frequency of the wobble signal WOB to match a predetermined reference frequency. The rotation speed control circuit 78 supplies the rotation speed signal RV to the spindle motor 72.

When the recordation signal processing circuit 79 records information data in the information data area 11 of the recording disc 73, the recordation signal processing circuit 79 first performs a predetermined modulation process to the information data to obtain a modulated information signal. The recordation signal processing circuit 79 then supplies the modulated information signal to the recordation/reproduction head 71 based on the disc address signal AD at a timing decided by the clock signal CK. The recordation/reproduction head 71 generates a recordation beam having an optical power, which corresponds to the modulated information signal, and irradiates the recordation beam on the land track LT in the information data area 11. Since the land track LT is formed at the constant linear velocity in the information data area 11, the spindle motor 72 causes the recording disc 73 to rotate such that the relative movement speed between the beam spot of the recordation beam and the surface of the recordation disc 73 becomes a constant value. By the above described operation, a string of recordation marks which correspond to the modulated information signal is recorded on the land track LT in the information data area 11 of the recordation disc 73 at a constant linear velocity.

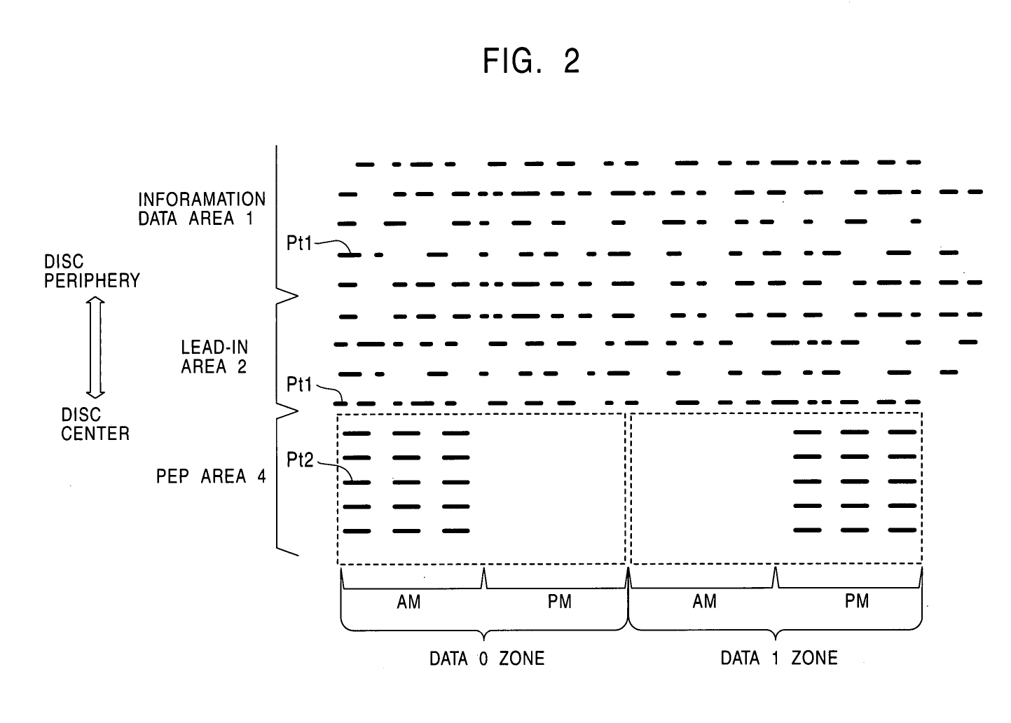

On the other hand, when recording the reproduction control data in the PEP area 44 of the recording disc 73, the recordation signal processing circuit 79 first performs a phase encoding process, as shown in FIG. 9A or 9B, to the reproduction control data to obtain a phase-encoded modulation signal. By this conversion, for instance, a bit of logic level 0 in the reproduction control data is converted to a phase-encoded modulation signal that fluctuates between the logic level 0 and the logic level 1 in the first half AM of a predetermined period TM, and stays at the logic level 0 in the second half PM of the period TM, as shown in FIG. 9A. On the other hand, a bit of logic level 1 in the reproduction control data is converted to a phase-encoded modulation signal that stays at the logic level 0 in the first half AM of the period TM and fluctuates between the logic level 0 and the logic level 1 in the second half PM of the period TM, as shown in FIG. 9B. The recordation signal processing circuit 79 supplies the phase-encoded modulation signal to the recording/reproducing head 71 based on the disc address signal AD at a timing determined by the clock signal CK. The recording/reproducing head 71 generates a recordation beam having an optical power corresponding to the phase-encoded modulation signal, and irradiates the recordation beam to the land track LT′ in the PEP area 44. Since the land track LT′ is formed in the PEP area 44 at constant angular velocity, the spindle motor 72 rotates the recording disc 73 at a constant angular velocity based on the rotation velocity signal RV. Consequently, a string of recordation marks, which corresponds to the phase-encoded modulation signal, is successively recorded on the land track LT′ formed in the PEP area 44 of the recording disc 73 at a constant angular velocity. When recordation for one rotation of disc (i.e., recordation of one track, or recordation of disc-one-rotation worth) is completed, the recordation signal processing circuit 79 utilizes the same phase-encoded modulation signal to repeatedly perform the above described recording operation to a plurality of land tracks LT. Because the recording disc 73 is rotating at a fixed angular velocity, the recordation marks on the adjacent land tracks LT are aligned with each other in the direction orthogonal to the track direction, like the recordation pits Pt2 shown in FIG. 2.

It should be noted that the present invention is not limited to the illustrated and described embodiment. It should be appreciated that those having an ordinary skill in the art may be able to carry out the present invention in different modes without departing from the spirit and scope of the present invention. The scope of the present invention is defined by the appended claims.

This application is based on a Japanese Patent Application No. 2002-111815, and the entire disclosure thereof is incorporated herein by reference.

### Industrial Applicabilitt

In the recording disc of the invention, a string of recordation marks which carries the information data is recorded along the track in the information data area. In the information data area, the disc address is recorded at a constant linear velocity. In the reproduction control data area (PEP area 4), on the other hand, the disc address is recorded at a constant angular velocity. Strings of recordation marks which carry the reproduction control data are recorded along a plurality of tracks in the reproduction control data area respectively such that the recordation marks align with each other in a direction orthogonal to the track direction. Therefore, when the reproduction control data is recorded on the recording disc, those recordation marks which represent the reproduction control data are recorded in the reproduction control data area such that the recordation marks align with each other in the direction orthogonal to the track direction without fault.

1. A recording disc for recording information data and reproduction control data which represents a method of reproducing the information data, the recording disc comprising:
an information data area for recording a string of first recordation marks which represents the information data, with disc addresses being recorded in advance in the information data area at a constant linear velocity, the disc addresses indicating positions on the recording disc; and
a reproduction control data area for recording a plurality of strings of second recordation marks, which represent the reproduction control data, along a plurality of neighboring tracks, respectively, such that the second recordation marks align with each other in a direction perpendicular to a track direction, with the disc addresses being recorded in advance in the reproduction control data area at a constant angular velocity.

2. The recording disc according to claim 1, wherein a track having a wobble shape, which corresponds to the disc addresses in the information data area, is formed in the information data area at the constant linear velocity whereas a track having a wobble shape, which corresponds to the disc addresses in the reproduction control data area, is formed in the reproduction control data area at the constant angular velocity.

3. The recording disc according to claim 1, wherein the recording disc is used for authoring only.

4. A recording device for recording information data and reproduction control data on a recording disc, the recording disc having an information data area to record the information data and a reproduction control data area to record the reproduction control data, the reproduction control data representing a method of reproducing the information data, the recording device comprising:
an information data area recording unit for rotating the recording disc at a constant linear velocity and recording a string of first recordation marks which represents the information data on a track in the information data area; and
a reproduction control data area recording unit for rotating the recording disc at a constant angular velocity, recording a disc-one-rotation-worth of string of second recordation marks, which represents the reproduction control data, along one track in the reproduction control data area, and repeatedly recording the same string of second recordation marks along at least one adjacent track in the reproduction control data area.

5. A recording method of recording information data and reproduction control data on a recording disc, the recording disc having an information data area to record the information data and a reproduction control data area to record the reproduction control data, the reproduction control data representing a method of reproducing the information data, the recording method comprising the steps of:
rotating the recording disc at a constant linear velocity and recording a string of first recordation marks which represents the information data on a track in the information data area; and
rotating the recording disc at a constant angular velocity, recording a disc-one-rotation-worth of string of second recordation marks, which represents the reproduction control data, along one track in the reproduction control data area, and repeatedly recording the same string of second recordation marks along at least one adjacent track in the reproduction control data area.
